(19) United States
(12) Patent Application Publication
(10) Pub. No.: US 2007/0219851 A1
(43) Pub. Date: Sep. 20, 2007

(54) APPARATUS AND METHOD FOR GENERATING AND DEVELOPING A SALES LEAD

(76) Inventors: Christopher Taddei, Santa Rosa, CA (US); Jonathan Cheriff, Windsor, CA (US); Chris Sigrist, Santa Rosa, CA (US); Chris Byerley, Oak View, CA (US)

Correspondence Address: SNELL & WILMER LLP (OC), 600 ANTON BOULEVARD, SUITE 1400, COSTA MESA, CA, 92626, US

(21) Appl. No.: 11/681,705

(22) Filed: Mar. 2, 2007

Related U.S. Application Data
(60) Provisional application No. 60/779,087, filed on Mar. 3, 2006.

(51) Int. Cl. G06F 17/30

(52) U.S. Cl. 705/10

(57) ABSTRACT

A user device displays advertisements that invite potential customers to respond. Responses to the advertisement (i.e. sales leads) are sent by the user device to a router. The router identifies the responding user device and compares the user device with a security blacklist. The router also compares the user response with an advertising campaign list and queues appropriate responses for routing to a salesperson client. When an salesperson client becomes available, the router routes the queued response to the salesperson client. The salesperson client establishes a communication channel through the router with the user device. This enables an interactive marketing session between the salesperson client and the user allowing a bot or salesperson to further develop the sales lead.

### CROSS REFERENCE TO RELATED APPLICATIONS

This patent claims the benefit of U.S. Provisional Application No. 60/779,087 filed on Mar. 3, 2006.

### BACKGROUND OF THE INVENTION

1. Field of the Invention

The invention relates to generating and developing sales leads. More particularly, the invention relates to an apparatus and method for generating and developing a sales lead in close to real time.

2. Description of the Related Art

A sales lead includes a name or other indicia of identity (e.g. a phone number, mailing address or email address) of a person or business that may have an interest in purchasing a product or service. A sales lead provides a starting point for a salesperson to further develop the lead by marketing a specific vendor's product or service. The salesperson develops the sales lead by gathering information about the potential customer and providing the customer with information about the vendor. This mutual exchange of information helps the salesperson to persuade the potential customer to purchase a product or service from the vendor. If the customer makes a purchase, the salesperson has converted the sales lead into a sales transaction. A sales lead with a high probability of being converted into a sales transaction is considered a good lead.

Sales leads are generated and developed over time using a variety of marketing strategies. For example, advertisements that invite a reader to respond to the advertisement are often placed in newspapers and periodicals. Many advertisements include a telephone number or an address for a potential customer to respond to the advertisement. If and when the reader responds, a sales lead is generated.

Trade shows provide a venue for a salesperson to generate and develop sales leads over time. The salesperson interacts with potential customers and shares information with them. Business cards and phone numbers are often exchanged generating sales leads for the salespersons. The salesperson may develop the lead further by listening to the specific needs of the potential customer and providing the potential customer with relevant information about the vendor's products and services.

Phone books, company directories and mailing lists also provide salespersons with sales leads. Salespersons develop these leads by cold calling or bulk mailing promotional material to these potential customers.

The internet provides salespersons with a rich medium to generate and develop sales leads. Internet advertisements often invite potential customers to contact a salesperson providing a telephone number, email address or a street address. Some internet advertisements also allow the potential customer to enter contact information so that a salesperson may contact them.

The sales lead development strategies described above are relatively slow asymmetric processes. The salesperson has to obtain the lead and then has to make contact with the potential customer to further develop the lead and advance the lead toward a transaction. By that time the potential customer may no longer be interested in the product or service or may have purchased a similar product or service from another vendor.

Those skilled in the art will appreciate that time lags in developing sales leads reduce the probability of converting the sales lead into a sales transaction. An apparatus or method that enables a salesperson to more effectively generate a sales lead and quickly develop the sales lead is needed. Applicant's invention addresses this need as well as others.

### BRIEF SUMMARY OF THE INVENTION

A user device receives an advertisement. A potential customer with the user device responds to the advertisement generating a sales lead. The user device sends the sales lead to a routing server. The routing server identifies the user device and determines if the device is blacklisted. The routing server also compares the sales lead with a sales campaign list to determine if the sales lead corresponds with a current campaign. If the sales lead is timely, the routing server queues the sales lead for routing to a salesperson client. When a salesperson client becomes available, the sales lead is routed to the salesperson client. The salesperson client responds to the sales lead by establishing an interactive communication channel with the user device. The communication channel enables an interactive marketing session between the user and the salesperson client allowing the salesperson client to develop the sales lead. The salesperson client may be controlled by a salesperson or a bot.

### BRIEF DESCRIPTION OF THE DRAWINGS

The exact nature of this invention as well as its objects and advantages will be readily understood upon consideration of the following specification as related to the attendant drawings wherein like reference numeral throughout the drawings indicate like parts, and wherein:

FIG. 1 shows a plan view of an embodiment of the apparatus of the present invention.

FIG. 2 shows an exemplary web page with a banner advertisement displayed on one of the user devices shown in FIG. 1.

FIG. 3 shows an exemplary graphical user interface of the salesperson client shown in FIG. 1.

FIG. 4 shows a flow diagram of an embodiment of the method of the present invention.

FIG. 5 shows an exemplary flow diagram of the operations performed by the routing server shown in FIG. 1.

### DETAILED DESCRIPTION OF THE INVENTION

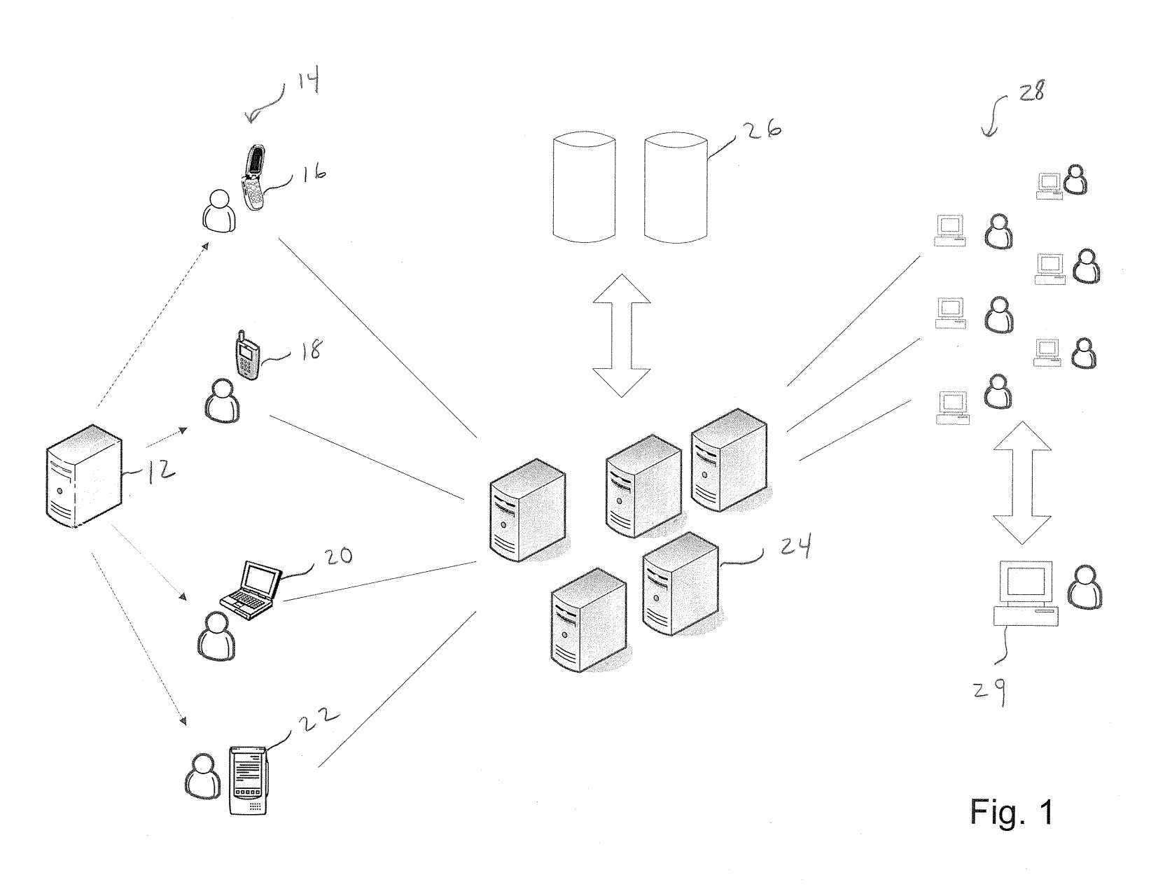

FIG. 1 illustrates a sales lead apparatus according to an embodiment of the invention. An advertisement server 12 is in communication with a plurality of user devices 14. The plurality of user devices includes a variety of different electronic devices, for example a cell phone 16, a digital wireless device 18, a laptop computer 20 and a personal digital assistant 22. The user devices 14 are in communication with a routing server 24 connected with a database 26. The routing server 16 is also in communication with a plurality of salesperson clients 28. The plurality of salesperson clients 28 are in communication with the master salesperson client 29.

The advertising server 12 generates advertisements that relate to a sales campaign. The advertising server 12 provides the advertisements to the plurality of devices 14 through an internet protocol. The plurality of user devices 14 display or play the advertisements. The advertisements invite a user to respond using their user device. If the user responds, a sales lead is generated.

Sales leads are sent from the plurality of user devices 14 to the routing server 24. The routing server 24 opens data stream channels between each of the responding user devices and the routing server 24. As data stream channels are opened, the routing server 24 identifies the responding user device and checks it against a blacklist. If the user device is on the blacklist, the routing server 24 sends a message to the user device and terminates the data stream channel. The routing server 24 also verifies that sales leads relate to an ongoing sales campaign. If a sales lead is not current, the routing server sends a message to the user device and terminates the corresponding data stream channel.

The routing server 24 routes sales leads to one of the plurality of salesperson clients 28 operated by a salesperson. If a salesperson client with a salesperson is unavailable, the routing server 24 determines if an appropriate artificial intelligent software robot (bot) is available. If so, the routing server 24 routes the sales lead to a salesperson client without a salesperson. If an appropriate artificial intelligent bot is unsuitable or unavailable, the routing server queues the sales lead. For each sales lead the routing server 24 routes to a salesperson client, the routing server opens another data stream channel.

Data streams between the plurality of user devices 14 and the plurality of salesperson clients 28 are routed through the routing server 24. The data streams allow the salespersons using the salespersons clients 20 to interact with potential customers to further develop sales leads. The routing server 24 stores the data streams in the database 26 creating a historic data log for quality assurance purposes.

The master salesperson client 22 provides system administration functions over the plurality of salesperson clients 28. The master salesperson client 29, for example allows a system administrator to take one of the salespersons clients offline or identify problems with a salesperson client or salesperson. The master salesperson client 20 also has quality assurance features that allow a supervisor to monitor the salesperson clients 28 and hence the work of the salespeople.

It should be noted that the plurality of salesperson clients 28 are not necessarily sponsors of a website. The plurality of salesperson clients 28 may belong to the advertisement publisher and may even be collocated with the advertisement server 12. Thus this embodiment of the invention may be embedded within existing advertising publisher systems and operate on a variety of different websites, integrating seamlessly with existing Internet websites, regardless of platform.

In this case, communication between a prospective customer using one of the user devices 16, 18, 20, 22 and the advertiser having a plurality of salesperson clients 28 would be direct, regardless of the website the advertisement appears on. The advertisement may be published by the advertiser or any third party ad serving network on one or multiple websites. The term website refers to any point of reference on the Internet, independent of whether the device used to access the Internet is a cell phone, Web TV, computer or other device.

The routing server 16 queues sales leads when a salesperson client is unavailable. In this embodiment, the sales leads are queued chronologically. Prioritizing the sales leads based on a likelihood of conversion, expected revenue, robustness of the data channels, packet loss expectations as well as salesperson abilities is also contemplated.

In this embodiment, the advertisements transmitted by the advertising server 12 to the plurality of user devices 14 are transmitted through an internet protocol. The use of other types of transmission channels and protocols such as television, satellite and cable is also contemplated.

The advertisements transmitted by the advertising server 12 are constructed using Macromedia Flash, Java, Microsoft XAML/Sparkle or any other multimedia technology.

The communication channel streams established between the plurality of user devices 14 and the routing server 16 and between the routing server 16 and the plurality of salesperson clients 28 are established using Real Time Messaging Protocol (RTMP), Extensible Message and Presence Protocol (XMPP) or any other suitable protocol. Higher level messaging standards such as AOL Instant Messenger, Yahoo Messenger, ICQ, MSN, XMPP, SMPP or equivalent may also be used.

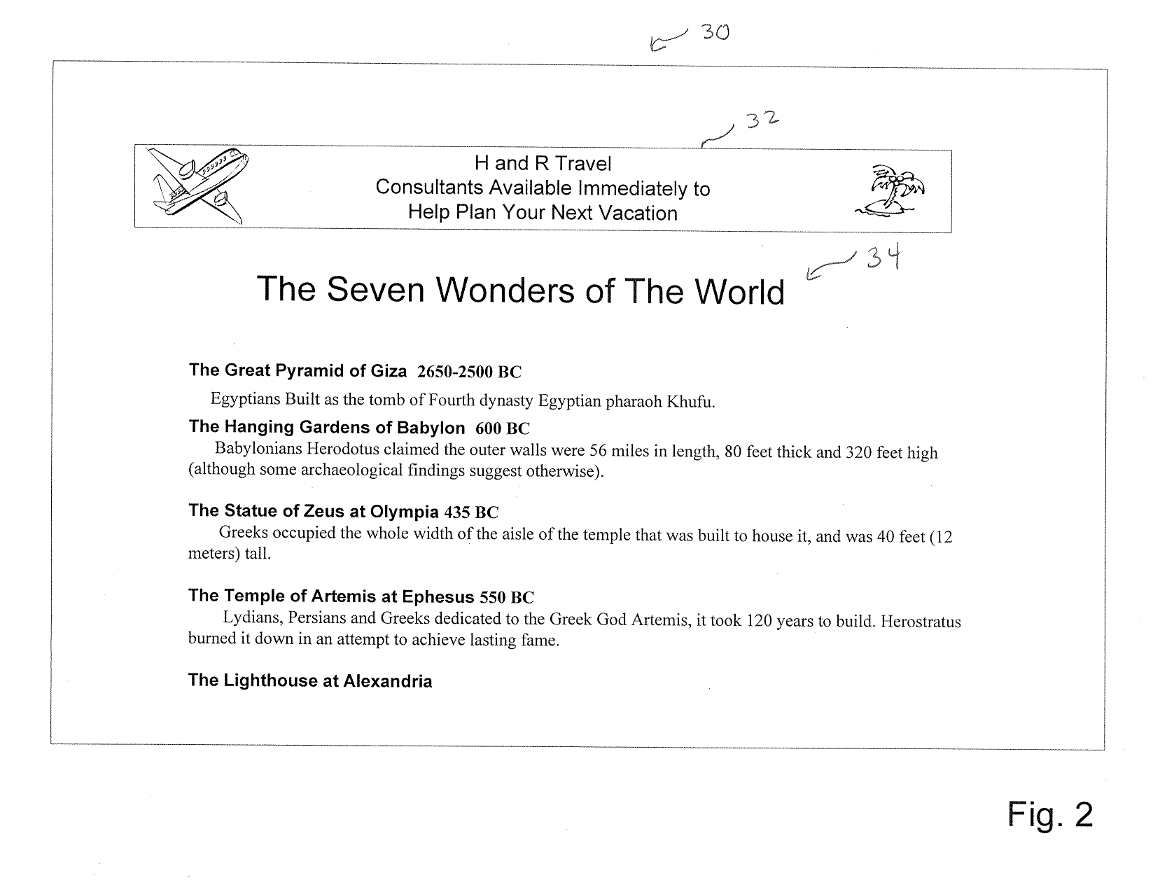

FIG. 2 shows an exemplary web page 30 displayed on one of the plurality of user devices shown in FIG. 1. The web page 30 has a banner advertisement 32 generated by the advertisement server. Below the banner advertisement 32 is web page content 34.

The banner advertisement 32 featured on the web page 30 is part of an advertisement campaign to generate sales leads for a travel service. A person reading this web page is invited to click on the banner advertisement 32. By clicking on the banner advertisement 32 a sales lead is generated. The sales lead is transmitted to the routing server and a communication channel is opened. The sales lead is then forwarded to one of the salesperson clients. The routing server extends the communication channel from the user device to the salesperson client enabling a salesperson to develop the sales lead.

When the user clicks on the banner advertisement 32, a dialog box, audio interface, video interface or other dialog medium will launch allowing the potential customer to interact directly with a salesperson through their user device. The launch of the medium does not inhibit the potential customer from viewing the contents of the web page 30.

The banner advertisement 32 may also provide Click-to-Talk capability. For example, the banner advertisement may include a text field allowing a viewer to input their telephone number. The routing server would take the number and determine an appropriate call center having a salesperson client to handle the call. The routing server acting as a proxy would immediately place two calls, one to the potential customer's phone and the second to the appropriate call center. The proxy would bridge the call and may even play a greeting or background music until the call is answered.

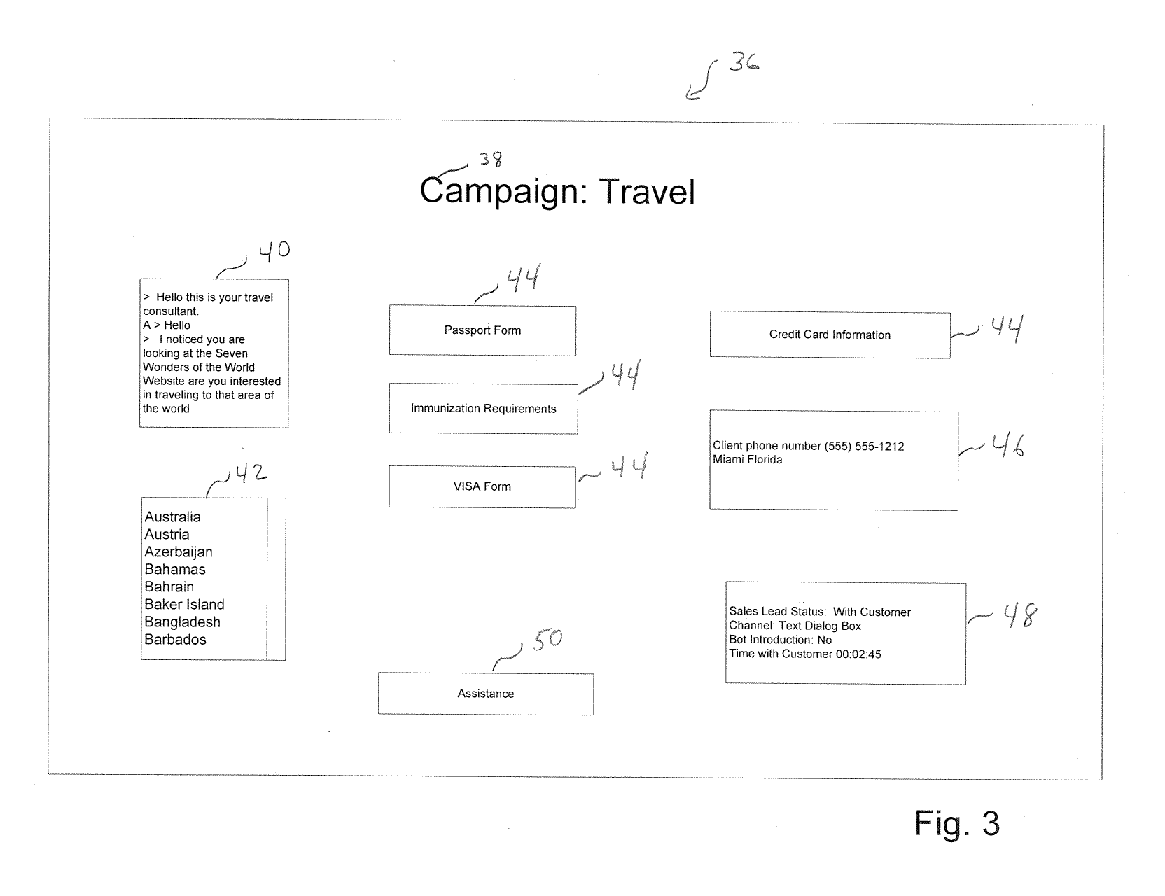

FIG. 3 shows an exemplary graphical user interface (GUI) screen 36 of the salesperson client shown in FIG. 1. The GUI screen 36 identifies the advertising campaign 38 for a sales lead that was created by a potential customer clicking on the banner advertisement 32 shown in FIG. 2.

The GUI screen 36 has a dialog box 40 that shows dialog between the potential customer and a salesperson. A scrollable window 42 contains a list of possible travel destination. The GUI screen 36 has a plurality of buttons 44 that push forms and other information to the potential customer. A text box 46 shows information about the potential customer that a salesperson has entered. A status box 48 displays information relevant to developing the sales lead. An assistance button 50 alerts the master salesperson client that assistance is needed.

The GUI screen 36 allows the salesperson to engage with the potential customer developing sales leads. Through the dialog box 40, the salesperson can work with the potential customer to identify their needs. The salesperson can also use the dialog box 40 to build rapport with the potential customer and persuade the potential customer to purchase a travel package. In this case, the salesperson knows that the client was looking at the Seven Wonders of the World website and can use that information to develop rapport by asking about their interests.

The scrollable window 42 allows the salesperson to select a travel location and provide the potential customer with information about a possible travel package to that location. The potential customer may for example be interested in vacation travel to the Bahamas. The salesperson can select the Bahamas in the scrollable window 42 and an information window about the Bahamas will appear. The salesperson may then convey to the potential customer information about airlines, hotels, and activities in the Bahamas.

The pushbuttons 44 provide for real time interaction between the salesperson and the potential customer. For example, the salesperson can electronically “push” a passport application form or a visa form to the potential customer. This creates a virtual presence allowing the salesperson to more effectively develop the sales lead and advance the sales lead toward a sales transaction.

The GUI screen 36 shown is an exemplary GUI screen related to a travel campaign. The GUI screens 36 for other campaigns and other industries vary. For example, the GUI screens 36 for a refinancing campaign in the mortgage industry may feature push buttons with refinancing forms and credit check authorization forms. Campaigns related to generating and developing sales leads in the timeshare, realty, legal and dental industries feature GUI screens adapted for those industries.

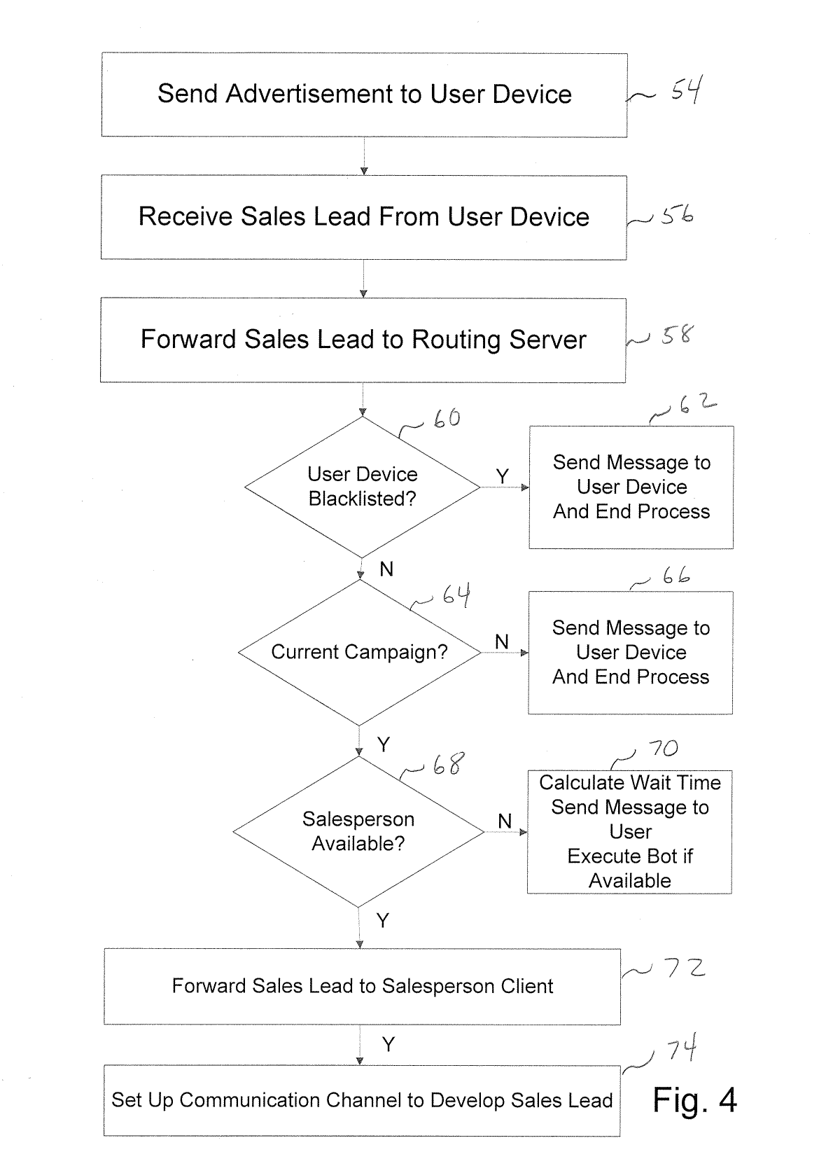

FIG. 4 shows a flow diagram 52 of an embodiment of the method of the present invention. An advertisement is sent to a user device 54. The advertisement invites a response from a potential customer. The advertisement for example may be a banner advertisement for a web page, an advertisement displayed at on an electronic kiosk, or an interactive television advertisement.

When the potential customer selects the advertisement, a sales lead from the user device is generated 56. That is, a potential customer has been identified. The user device then forwards the sales lead to a routing server 58. The routing server 58 then identifies the user device and cross checks the user device against a list of blacklisted user devices to see if the device is blacklisted 60. The user device blacklist may include for example a list of IP addresses of user devices that have previously abused the system.

If the user device is blacklisted 60, the routing server sends a message to the user device and ends the sales lead development process 62. That is, the routing server terminates the communication channel with the user device and discards the sales lead.

If the user device is not blacklisted 60, the routing server identifies the advertising campaign that is associated with sales lead. The routing server determines if the advertising campaign is a current campaign 64. If it is not 64, the routing server sends a message to the user device and ends the sales lead development process 66. That is, the routing server terminates the communication channel with the user device.

The routing server then determines if a salesperson is available 68. If not, the routing server calculates a wait time and sends a message to the user device 70. The user device may execute a bot if one is available 70. The bot may engage a potential customer completely or the bot may gather preliminary information until a salesperson becomes available.

If a salesperson is available, the sales lead is forwarded to a salesperson client 72. A communication channel between the user device and the salesperson client is established 74. The communication channel between the user device and the salesperson client enables a salesperson using the salesperson client to have an interactive sales session between the salesperson and the potential customer to further develop the sales lead.

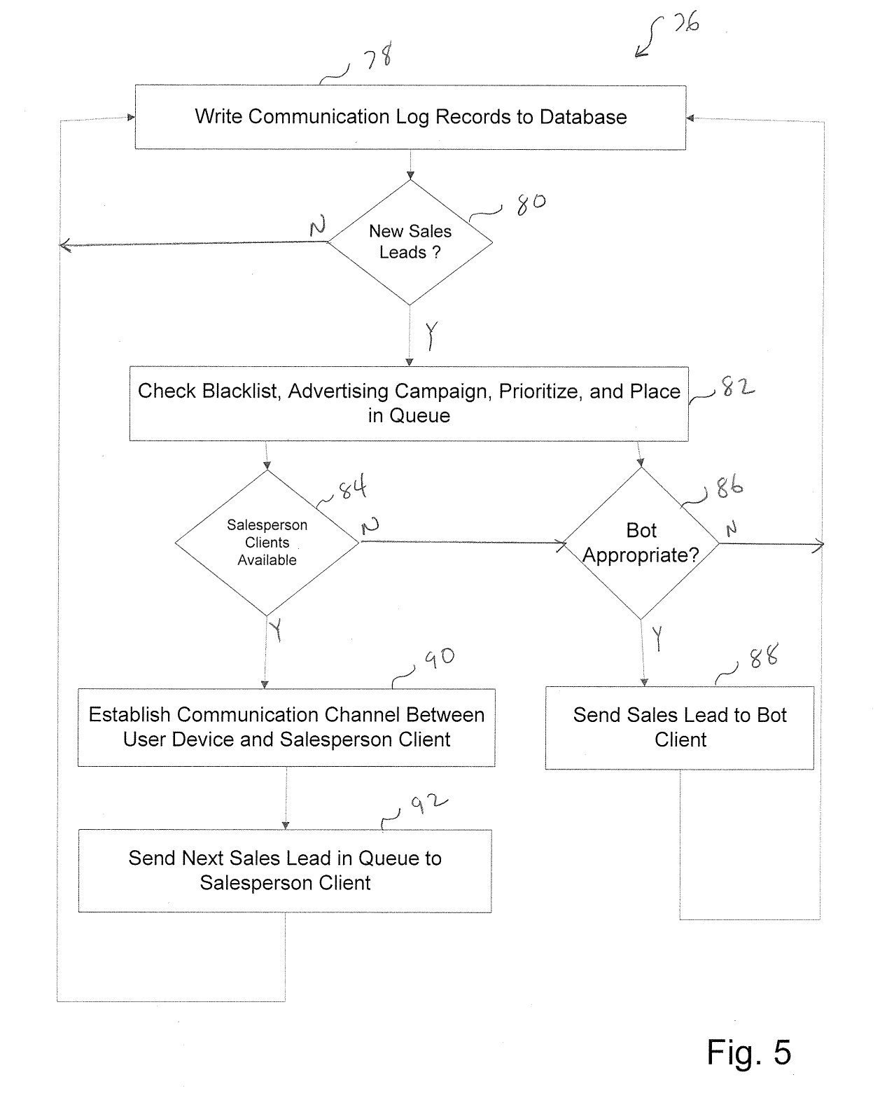

FIG. 5 shows an exemplary flow diagram of the operations performed by the routing server shown in FIG. 1. The routing server writes communication log records to the database 78. The records are preserved in the database to memorialize sales transactions and to have a historic sales log for quality assurance purposes. Since data streams are routed through the routing server, a comprehensive log of operations is available in the database.

The routing server next determine if any new sales leads 80 have been forwarded from user devices 80.

The routing server then compares any sales leads with user device blacklist, the current advertising campaign list, prioritizing the sales leads and placing the sales leads in a queue 82. The priority of the sales leads may be a function of many factors including the type of sales lead, the type of advertising campaign, the estimated time to develop the lead, the transmission rate of the user device as well as any other relevant factors.

The routing server then checks to see if any salesperson clients with salespersons are available 84. If none is available, the routing server determines if the sales lead is bot appropriate 86. If the sales lead is bot appropriate, the sales lead is sent to a bot client 88.

If there a salesperson client is available 84, the router establishes a communication channel between the user device and the salesperson client 90. The router then sends the next sales lead in the queue to the salesperson client 92 so that a salesperson may begin an interactive sales lead development session with the potential customer.

Obviously many modifications and variations of the present invention are possible in light of the above teachings. It is therefore to be understood that within the scope of the appended claims that invention may be practiced otherwise than as specifically stated.

What is claimed is:

1. An apparatus for generating and developing a sales lead, the apparatus comprising:
a user device operable to receive an advertisement and a user response to the advertisement generating the sales lead;
a routing server in communication with the user device for routing the sales lead; and
a salesperson client in communication with the routing server for receiving the sales lead and opening a link for interactively engaging with the user device for developing the sales lead.

2. The apparatus of claim 1 wherein the salesperson client is a bot that interactively engages the user device.

3. The apparatus of claim 3 wherein the salesperson client is operable to establish a text messaging channel with the user device.

4. The apparatus of claim 1 wherein the salesperson client is operable to establish a voice channel with the user device.

5. The apparatus of claim 4 wherein the client is operable to establish video channel with the user device

6. The apparatus of claim 1 wherein the salesperson client is a thin client.

7. The apparatus of claim 1 wherein the salesperson client is a computer application.

8. The apparatus of claim 1 wherein the routing server queues and prioritizes the sales leads.

9. The apparatus of claim 1 further comprising a data logger connected with the routing server for recording data stream traffic between the salesperson client and the user device.

10. The apparatus of claim 1 wherein the user device is a cell phone.

11. The apparatus of claim 1 wherein the user device is a personal digital assistant.

12. The apparatus of claim 1 wherein the user device is a personal computer.

13. A method for generating and developing a sales lead, the steps of the method comprising:
sending an advertisement to a user device;
the user device responding to the advertisement thereby generating the sales lead;
forwarding the sales lead to a routing server;
the routing server routing the sales lead to a salesperson client; and
the salesperson client developing the sales lead by interactively engaging the user device.

14. The method of claim 13 further comprising the step of queuing a sales lead for routing to the salesperson client.

15. The method of claim 13 further comprising setting up a communication channel between the salesperson client and the user device.

16. The method of claim 15 wherein data streams in the communication channel are routed through the routing server.

17. The method of claim 16 wherein the data streams are stored in a database.

18. A method of implementing a sales campaign, the steps of the method comprising:
generating a banner advertisement for a web page;
selecting the banner advertisement on a user device;
setting up a communication channel between the user device and a salesperson client; and
interactively engaging the user device and the salesperson client to advance a sales transaction.

19. The method of claim 18 wherein the user device is a computer and the banner advertisement is on a web page.

20. The method of claim 18 wherein the communication channel is routed through a routing server.

21. The method of claim 18 wherein the user device and the salesperson client interactively engage through text messaging.

22. The method of claim 18 wherein the user device and the salesperson client interactively engage through audio messaging.

23. The method of claim 22 wherein the user device and the salesperson client interactively engage through video messaging.
